(19) United States
(12) Patent Application Publication
(10) Pub. No.: US 2007/0179829 A1
(43) Pub. Date: Aug. 2, 2007

(54) Method and apparatus for workflow scheduling and forecasting

(75) Inventors: Erian Laperi, Wentzville, MO (US); Jeremy Andrew Dilks, East Alton, IL (US); Jonathan S. Gray, Hazelwood, MO (US); Joel E. Palmer, Florissant, MO (US)

Correspondence Address: BRINKS HOFER GILSON & LIONE, P.O. BOX 10395, CHICAGO, IL, 60610, US

(73) Assignee: SBC Knowledge Ventures, L.P.

(21) Appl. No.: 11/341,740

(22) Filed: Jan. 27, 2006

(51) Int. Cl. G06F 15/02

(52) U.S. Cl. 705/9

(57) ABSTRACT

A method and system for workflow scheduling and forecasting is disclosed. The method may include automatically generating a predicted workforce schedule for a work tour period, such as a period of several weeks or months, and populating the workforce schedule with workforce members based on prioritized work tour preferences received from the workforce members. A current workload assessment may then be applied to the populated workforce schedule based on current assignment availability and predicted workload for later in the current day. The system may include a workload database, A workforce scheduling server, and a workload allocation server. The workload database contains currently available assignments and historical workload levels and a business rule database containing workforce hours requirements. The workforce scheduling server generates a workforce schedule that the workload allocation server uses to distribute existing, and predict future, tasks among the scheduled workforce.

### TECHNICAL FIELD

The disclosure below relates to workflow scheduling and forecasting for entities with dynamic workload activities, such as communication network troubleshooting.

### BACKGROUND

Users of network systems invariably run across difficulties with connectivity or the availability of certain services for their account. Service providers and networks carrying various user services expect to receive a number of service calls and questions relating to connectivity or help with accessing or using particular services. These networks and service providers need to provide troubleshooting solutions in an efficient manner. With larger networks or service providers, the challenge is not only to quickly and correctly answer questions and provide solutions to problems, but also to proficiently handle the dissemination of trouble tickets to the appropriate technician in the system and manage the administrative overhead. The administrative overhead may include managing the availability of the workforce handling the trouble tickets and addressing the need to assign a variable workload of trouble tickets among available workforce resources.

Due to the fluctuating workflow inherent in service oriented tasks such as network troubleshooting and helpline call centers, companies with these type of tasks need to organize their workforces to provide the necessary support for their customers regardless of the demand. Challenges exist, however, not only with trying to predict how much manpower is necessary at any given time to handle the workload, but also with how to handle situations where earlier workload estimates fall short of actual need. Accordingly, there is a need to provide improved workforce scheduling and management, such as in network troubleshooting tasks.

### BRIEF DESCRIPTION OF THE DRAWINGS

FIG. 1 illustrates an embodiment of a workforce scheduling and workload allocation system.

FIG. 2 is a flow diagram of an embodiment of a workforce scheduling process executable on the system of FIG. 1.

FIG. 3 is a flow diagram of an embodiment of a workload allocation process executable on the system of FIG. 1.

FIG. 4 illustrates a screen of a graphic user interface for viewing work schedule information that may be displayed at the client shown in FIG. 1.

FIG. 5 illustrates an alternate screen of the graphic user interface of FIG. 4.

FIG. 6 illustrates a screen of a graphic user interface for viewing workload allocation information that may be displayed at the client shown in FIG. 1.

FIG. 7. illustrates a first alternate screen of the graphic user interface for viewing workload allocation information of FIG. 6.

FIG. 8. illustrates a second alternate screen of the graphic user interface for viewing workload allocation information of FIG. 6.

FIG. 8A is a window accessible via the screen of FIG. 8 providing a forcing tool for adding additional workload assignments to workforce member schedules.

FIG. 9 illustrates a third alternate screen of the graphic user interface for viewing workload allocation information of FIG. 6.

FIG. 10 is an example of an automated email that may be generated by the system of FIG. 1 to indicate escalation of a trouble ticket based on duration.

FIG. 11. is an example of an automated email that may be generated by the system of FIG. 1 to indicate escalation of a trouble ticket based on multiple dispatches.

FIG. 12 is a block diagram of a general computer system adaptable for use in the system of FIG. 1

### DETAILED DESCRIPTION

In order to address the need for improved and effective management of workforce resources with dynamic workload issues, a method and system for workflow scheduling and forecasting is described herein. In one aspect, a system may include a workload database containing currently available assignments and historical workload levels and a business rule database containing workforce hours requirements. A workforce scheduling server may include a workforce schedule application configured for automatically generating a workforce schedule based on data from the workload database and the business rule database, where the workforce schedule consists of a plurality of work tours and each work tour has a predetermined daily schedule for the length of the work tour. The workforce scheduling server may also include a work tour bidding application configured to receive work tour preference requests from workforce members and automatically populate the generated workforce schedule such that each of the workforce members is associated with a respective one of the plurality of work tours. Also, the system may include a workload allocation server in communication with the workforce scheduling server, the workload allocation server having an assignment distribution application configured to forecast a daily workload based on the currently available assignments and historical workload levels, and configured to distribute assignments to each of the workforce members on the populated workforce schedule in response to the forecasted daily workload.

In another aspect, a method for dynamically arranging work schedules is described. The method includes retrieving historical workload data from a workload database and business rule data from a business rule database. A workforce schedule template is automatically generated and includes a plurality of work tours based on the retrieved historical workload data and business rule data, where each work tour has a predetermined daily schedule for a length of the work tour. Work tour preference requests are received via a graphic user interface from workforce members. The method then describes automatically generating a populated workforce schedule by populating the workforce schedule template based on the received work tour preference requests, where each of the workforce members is assigned to a respective one of the plurality of work tours.

In other versions of the method, the populated workforce schedule and currently available assignments and historical workload levels may then be used to make real-time predictions and adjustments for that day's actual workload. The currently available assignments and historical workload are retrieved from the workload database. A forecasting of a present day workload based on the currently available assignments and historical workload levels is then performed. After forecasting present day workload, assignments are automatically distributed to each of the workforce members on the populated workforce schedule.

According to another aspect, an article of manufacture, such as a computer readable medium, may be provided containing instructions for executing the steps of the method noted above. Additional features may include, instructions for automatically prioritizing an order of the plurality of telecommunications user accounts assigned to the technician based on at least one priority parameter, such as a length of time that a trouble ticket for the telecommunications account has waited for attention. The computer readable medium may also include instructions for automatically updating an activity log associated with the telecommunications user account with diagnostic test activity and results from the workflow. Also, the instructions may include an option for exempting the technician from following the automatically suggested workflow upon receipt of an exemption request from the technician.

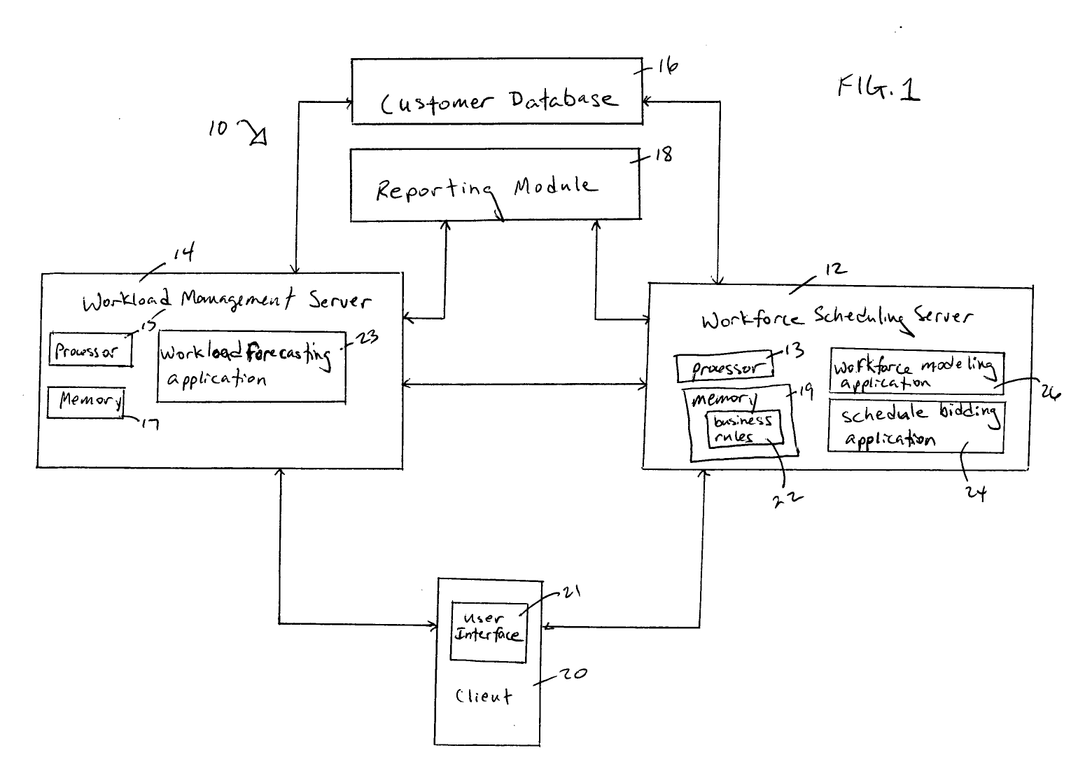

In order to provide for improved scheduling capabilities and workforce allocation, and to permit improved management and communication of work tours or workload changes, a system 10 is disclosed in FIG. 1 having a workforce scheduling server 12 and a workload management server 14. The system 10 includes a customer database 16 in communication with the workforce scheduling and workload management servers 12, 14. The customer database 16 may be one or more servers containing customer connectivity information, service choices, billing address information, trouble ticket reports and other general customer information, including historical data on prior trouble tickets handled. The customer database may be configured in a WFA (workflow administration) format or other commonly known database format. One suitable WFA format is supported by Telcordia Technologies, Inc. of Piscataway, N.J. The workforce scheduling server 12 and/or workload management server 14 may each have a database communications module for communicating with the customer database using, for example, a TN3270 session.

The workforce scheduling server 12 and workload management server 14 each receive updates on WFA reporting applications from a workflow process reporting module 18. Suitable reporting applications may include Open Query System (OQS), Symposium ACD or other known Web-based reporting tools. The system 10 includes one or more clients 20 in communication with the workforce scheduling server 12 and/or the workload management server 14. In one embodiment, the client 20 may be a personal computing device such as a personal computer with standard Internet web browser, and having an interface 21 through which a user may communicate with the servers 12, 14 at standard IP addresses.

The workload management and workforce scheduling servers 14, 12 are shown as two separate systems for convenience. The functionality described below for the workforce scheduling server and workload management server may be incorporated onto a single device or a distributed network of devices in other implementations. The servers 12, 14 may be implemented as UNIX-based servers having processors 13, 15 in communication with respective memories 17, 19 and applications containing instructions for carrying out the methods described herein.

The workforce scheduling server 12 may include a business rule memory 22 and schedule bidding module 24 in communication with a workforce modeling application 26. The workforce scheduling server 12 utilizes these applications and modules to generate a daily manpower schedule for a particular work tour. As used herein, the term work tour is intended to mean any predetermined grouping of work days useful for a particular business to plan its operations. As one example, a telephone call center manned by network center technicians (NCTs) may organize its work schedules by work tours of six week periods.

The business rule memory 22 may contain work tour length information, working hour requirements and limitations specific to the particular company and type of work that the workforce scheduling server is preparing a schedule for. Examples of other business rules that may be contained in the business rule memory 22 include hours of operation for the business, the minimum number of days off per work tour required by the contracts or union for the workforce members, and the percentage of the workforce that may have a day off on any given day in a work tour. The business rules may also include a seniority ranking of each member in the workforce.

The workforce modeling application 26 is configured to review historical workload reports and predict the number of people that are necessary to schedule for each day of an upcoming tour based on this historical information. The historical information may be retrieved from the customer database 16 and the reporting module 18 by the workforce scheduling server 12 for the relevant time period or specific dates. By weighting the historical information and then applying relevant business rules from the business rule memory 22, the workforce modeling application may automatically generate a schedule template.

The schedule bidding module 24 in the workforce scheduling server 12 may consist of a server-based application that allows users at client devices 20 to interface with the workforce scheduling server 12 via a standard Internet web browser interface such as Internet Explorer. Qualified users may be individual workforce members, such as NCTs for a telephone company as mentioned above. These qualified workforce members may access the schedule bidding application to submit bids or preferences for when they would like to work during a particular tour. The tour schedule generated by executing the workforce modeling application 26 may be made available for review by the qualified users as a reference so that specific work days, or vacation days may be requested. Also, requests may be made for certain shifts, for example a 7 a.m.-2 p.m. shift, available on the tour schedule. The schedule bidding module 24 may be configured to apply priority to requests for work tours from specific members of the workforce based on that individual's seniority or other factor maintained in the business rule memory 22.

The workforce scheduling server 12 may be provisioned to communicate with the workload management server 14 after the workforce scheduling server finalizes a work tour schedule and populates it with workforce members at the available days and shifts. Also, the workload management server 14 may communicate with the customer database 16. The customer database 16 may be configured in any of a number of customer database formats such as WFA/C or TIRKS type database formats. The modules and applications in the workforce scheduling server 12 and the workload management server 14 may be implemented with JAVA or VB script functions. In one embodiment, the servers 12, 14 may be programmed in Perl and configured to work with a customer database provisioned in IMSC65 WFA4-C or TIRKS format available from Telcordia Telecommunications, Inc.

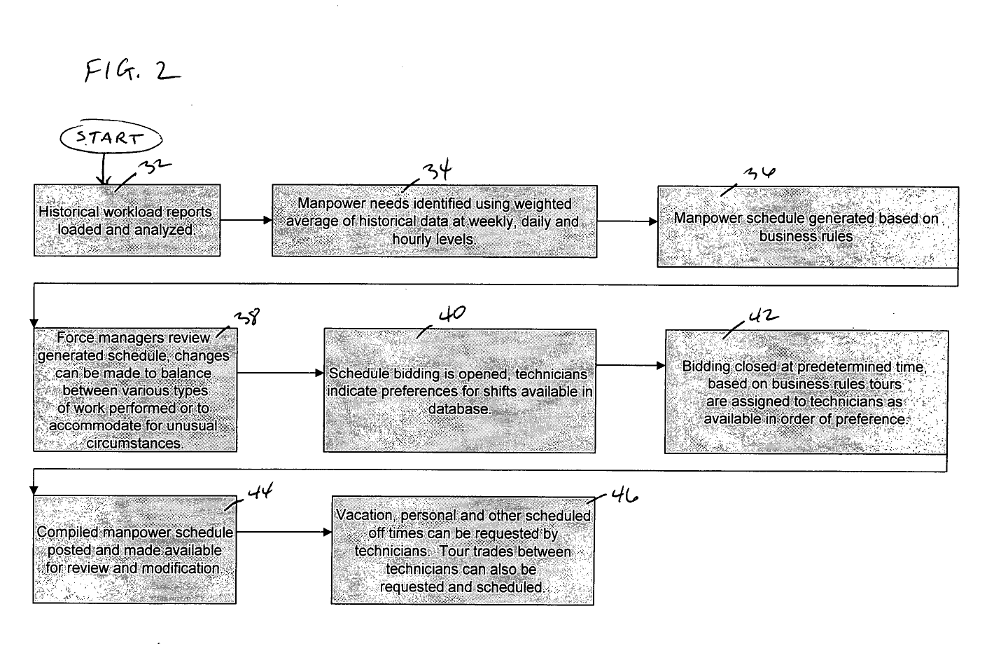

Referring to FIG. 2, an overview of a schedule generation process 30 supported by a workforce scheduling server 12 such as disclosed in FIG. 1 is described. To generate a work tour template, historical workload reports are loaded into the workforce scheduling server 12 from the customer database 16 and/or reporting module 18 (at step 32). The manpower needs for the work tour period are calculated with the workforce modeling application 26 using weighted averages of the historical data from the historical workload reports (at step 34). The weighted average historical data is, in one embodiment, analyzed at the weekly, daily and hourly increments. These increments may be changed as best suits a particular application. After determining the manpower needs in terms of the number of hours calculated to address a predicted future workload, the workforce schedule template is generated based on business rules from the business rules database 22 (at step 36).

The business rules database 22 helps to shape the workforce schedule template based on the hours of operation of the particular entity, the number of hours permitted per work force member, minimum number of days off expected for workforce members, the number of consecutive days off, and other business rules appropriate to the particular entity. As one example, a business rule for a call center staffed by NCTs may work on the assumption that up to ten percent of the workforce may be off on any given day. Once the workforce schedule template has been generated, authorized managers may review the generated schedule and make changes to accommodate specific types of work or circumstances (at step 38). The authorized managers may access the workforce schedule template through a user interface, such as an Internet web browser interface using an even number of authentication mechanisms, such as standard login and password queries.

Workforce members, after generation of the workforce schedule template and any alterations by authorized managers, may access the workforce schedule template and submit preferences for shifts available on that workforce schedule (at step 40). Individual workforce members may access the schedule bidding application 24 in the workforce scheduling server 12 via a user interface 21 from a client device 20. The user interface provided from the schedule bidding application to client devices may be an Internet-based web browser interface with appropriate authentication procedures. Alternatively, the user interface 21 may only be accessible via dedicated terminals at the company premises. Work tour bidding will be closed after a predetermined period of time, for example within seven days of publication of the workforce schedule, and then the schedule bidding application 24 assigns workforce members to available shifts (at step 42).

The schedule bidding application 24 may apply a first-come, first-serve algorithm to incoming requests for shifts, or may utilize a prioritization algorithm based on one or more parameters. These parameters may include workforce member seniority, subject matter expertise, and so on. After the close of the predetermined bidding period, the populated workforce schedule will be posted and made available for review (at step 44). Requests for changes to the workforce schedule may be made after the close of the bidding process, and even during the calendar period within which the workforce schedule applies, for requests for vacation or work tour trades (at step 46).

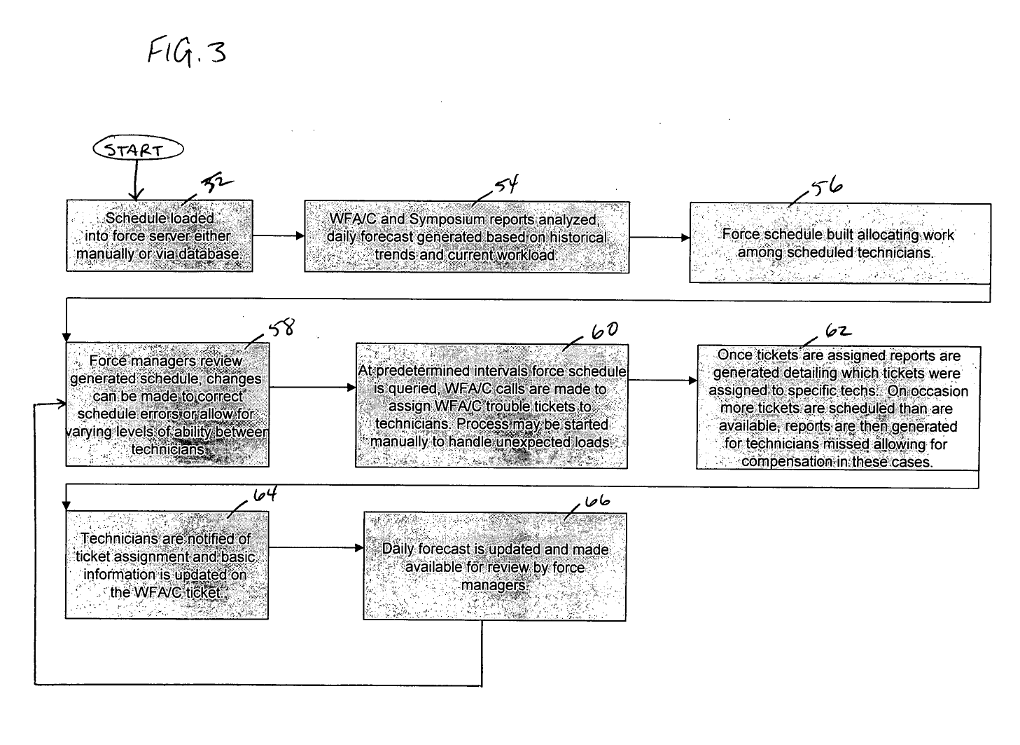

At the conclusion of the process of generating a workforce schedule, and on the first calendar day encompassed by the workforce schedule, a separate workload forecasting process makes use of the workforce schedule with previously predicted workloads and takes into account the real-time demand for completion of currently pending assignments to continually update the number of assignments required by each workforce member during their particular tour. As illustrated in FIG. 3 and example of this real-time workload forecasting process 50 is shown. The workforce schedule discussed above is loaded into the workload management server 14 (at step 52). The loading of the schedule may be automatic via a communication link between the workforce scheduling server 12 and the workload management server 14. Alternatively, the workforce scheduling server 12, rather than automatically forwarding a populated workforce schedule to the workload management server, or rather than responding to a query from the workload management server, may simply output the workforce schedule in electronic form for later manual loading into the workload management server 14. The electronic format of the workforce schedule may be any of a number of known formats, such as Microsoft Excel.

The workload management server 14, via the workload forecasting application 23, then accesses customer database information and reporting information from the customer database 16 and reporting module 18 and uses this information to generate a workload forecast for the day based on the current data and the historical data (at step 54). The customer data may be in the form of WFA/C information and the reporting data may be obtained from reporting programs such as Symposium ACD software available from Nortel. The daily workload forecast may be based on any number of prediction algorithms taking in account the currently received number of assignments, for example trouble tickets, for a given time increment and predicting future hour workloads based on this current information and on the historical data for that same hour or day.

The workload management server, after determining a workload forecast for the day, allocates work assignments among workforce members on the workforce schedule (at step 56). Authorized managers are provided with an interface having a link to the generated schedule and can make changes to correct scheduling errors or allow for varying levels of ability between workforce members (at step 58). An example of a schedule error may include instances where a technician did not intend to take a vacation and is available for receiving an assignment workload that day. Due to varying levels of ability between workforce members, a manager's schedule corrections, or automated allocations by the workload allocation server, may also be based on the workload level that the specific workforce member is expected to maintain.

In one example, the company employing the workforce member may have a policy of expecting a one hundred percent workload from work force members having more than three years of experience, seventy-five percent workload capacity for workforce members having less than three years experience but more than one years experience, and a fifty percent workload capacity for workforce members with less than one year experience. In this example, the workforce members may be NCTs and the workload may refer to the number of trouble tickets to be handled per hour or per shift. After this initial assignment of workload to the various workforce members, and review by the managers, the workload management server queries the customer database at predetermined intervals, for example every half hour, and compares the current assignment allocated from the earlier work forecast to the number of assignments needing attention. This periodic check helps to make sure that the previously generated schedule matches the reality of the workload for the day (at step 60).

After the trouble tickets are assigned to specific workforce members, the workload management server generates reports (at step 62). The reports may include the number of trouble tickets that were assigned vs. number of tickets scheduled/forecasted for assignment and running total of tickets assigned to each member. There may be instances, for example, where the workload forecast indicated a need to load 100 tickets at 10 a.m., but if there are not enough tickets at 10 a.m. the actual number loaded into the work schedule may only be 80. These reports of loaded vs. forecasted may include a percentage to display the accuracy of the forecast vs. real load and also be used for improvements in future loading.

The individual technicians are then notified of their work assignments and the information in the customer database is updated to reflect assignment of the specific trouble ticket to a particular NCT (at step 64). The technician notification may take the form of an automated email generated by the workload management server 14. In a final task for a given iteration of the daily workload forecast, the workload management server 14 then updates the daily forecast based on the previous forecast and reality comparison checks and makes available to the managers the updated workload schedule (at step 66).

In one application of the workload allocation process 40 shown in FIG. 3, the forecasting and updating of the real-time workload schedule may be repeated in half hour intervals. Trouble tickets allocated in a previous iteration of the workload forecasting assignment may be dynamically reallocated based on new calls with live customers that may take precedence over previously received calls or messages requiring call back or other reported problems that do not involve a live customer waiting for immediate response.

As noted above, any of a number of forecasting formulas may be used for generating a workforce schedule template, as in the example provided in FIG. 2 above, and in generating a workload allocation schedule utilizing the workforce schedule as described in FIG. 3 above. One example of an algorithm for determining the workforce schedule which may be used by the workforce scheduling server 12 involves a forecast formula that uses the weighted average of the previous instances of that day of the week for the previous number of weeks equal to the length of the next work tour were being calculated. For example, a six week work tour would involve calculating coefficients for six prior instances of the particular day being reviewed and may be expressed, in one example, as follows:

$$\begin{matrix}{A}_{[ d , h ]} = {T}_{[ d , h , 0 ]} * ( 0.25 ) + {T}_{[ d , h , 1 ]} * ( 0.25 ) + \\ {T}_{[ d , h , 2 ]} * ( 0.166 ) + {T}_{[ d , h , 3 ]} * ( 0.166 ) \\ = {T}_{[ d , h , 4 ]} * ( 0.0833 ) + {T}_{[ d , h , 5 ]} * ( 0.0833 )\end{matrix}$$

Where d ranges from 0 to 6 inclusive, and where 0 equals Sunday and h ranges from 0 to 23, inclusive. This calculation of the number of work items received on an average per hour per day of the week calculation is then combined with weighted average of the number of work items received on an average day of the week. This may be expressed, in one example as follows:

$$\begin{matrix}{A}_{[ d ]} = {T}_{[ d , 0 ]} * ( 0.25 ) + {T}_{[ d , 1 ]} * ( 0.25 ) + \\ {T}_{[ d , 2 ]} * ( 0.166 ) + {T}_{[ d , 3 ]} * ( 0.166 ) \\ = {T}_{[ d , 4 ]} * ( 0.0833 ) + {T}_{[ d , 5 ]} * ( 0.0833 )\end{matrix}$$

Where:

h=Hour of day.

d=Day of week.

w=Week.

T[d, h, w]=Number of work items received in [h] hour of [d] day in [w] week.

A[d, h]=Average number of work items received in [h] hour on [d] day.

T[d, w]=Number of work items received on [d] day of [w] week.

A[d]=Average number of work items received on [d] day.

In the above example equations, the final subscript is the index of the week being used, from 0 (the most recent week) to 5 (six weeks ago). The weighting and the number of weeks used are configurable options that may be altered to allow for more accurate forecasting if the data being forecast displays a significant rate of change requiring a finer granularity in forecast.

As described with respect to FIG. 3 above, the workload allocation process may be a more real-time, dynamic process of allocating workload among those scheduled in the workforce schedule. Here the calculation may include the current workload to be assigned and the previous average calculated. The workload allocation calculations may be iterated multiple times a day, for example every half hour of the day, to make intra-day adjustments. One example of a suitable algorithm for making intra-day scheduling adjustments is shown below, where:

h=Hour of day.

d=Day of week.

w=Week.

A_{[h]}=Average number of work items received during [h] hour on this day of the week (from above).

T_{[h]}=Number of work items received during [h] hour today.

E_{[h]}=Expected number of work items received during [h] hour today.

E=Expected work items to be received for today.

Calculating the expected number of tickets in a given hour period for ticket assignment:
E_{[h]}=((Σ₀^{h-1}T_{[h]})/(Σ₀^{h-1}A_{[h]}))*(A_{[h]})
Calculating the expected number of tickets for an entire day:
E=((Σ₀^{h-1}T_{[h]})/(Σ₀^{h-1}A_{[h]}))*(Σ₀²³A_{[h]})

In the first equation the sum of the number of work items received per hour for today is divided by the sum of the number of work items received per hour on an average day, then the result is multiplied by the number of work items received in this hour on an average day. In the second equation we are taking the sum of the number of work items received per hour for today and dividing by the sum of the number of work items received per hour on an average day, then multiplying the result by the number of work items received in the sum of all work hours on an average day.

During any given day of the work tour, there may be a point where the workload allocation requirements exceed the abilities of the workforce to handle during regular shifts and overtime will need to be scheduled. When generating the original workforce schedule, an assumption may be made as to how many work items per hour individuals may handle and the workforce schedule may be adjusted to accommodate for potential additional workload items such that overtime is not automatically required if just a small number of additional work assignments need handling for that particular day. However, once that threshold or buffer has been exceeded, and the scheduled workforce cannot reasonably absorb the extra work, the workload management server 14 will also provide managers with the ability to forecast the appropriate number of overtime hours required to meet current and predicted service levels.

In calculating such a buffer, certain assumptions may be made and entered as parameters in the workforce schedule server and the workload allocation server. For example, each workload item (e.g. trouble ticket) may be priced/weighted as needing 15 minutes and the capability of NCTs to handle these items assumed to be four items per hour. If the buffer exceeds 4 work items per hour per employee then management may be notified about possible need for overtime.

One example of an algorithm for calculating this overtime is provided below where:

An_{[h]}=Average number of work items received during [h] hour on this day of the week (from above).

Tn_{[h]}=Number of work items received during [h] hour today.

En_{[h]}=Expected number of work items received during [h] hour today.

En=Expected work items to be received for today where n is an index of a particular type of work item.

M=Man-hours remaining for today (determined from work schedule).

Kn=Man-hour coefficient for work items of type n.

O=Man-hours of overtime required.

H0=Current hour of day.

H1=Hour of day for end of service level.

I=Index of individual work item.

Calculating the number of man-hours of overtime required to meet service level criteria:
O=(Σₙ₌₀^{I}(Kn*Σ_{h=H0}^{H1}En_{[h]}))−M
In this equation we are taking the sum of the required number of man-hours for each type of work item for each remaining hour in the day (up to our service level commitment). Man-hours per type of work item is a configurable parameter expressed in fractions of an hour. This particular overtime example takes into account the type of work item (designated as “n”) such as the difference between a live call from a trouble ticket and an internal network connection review.

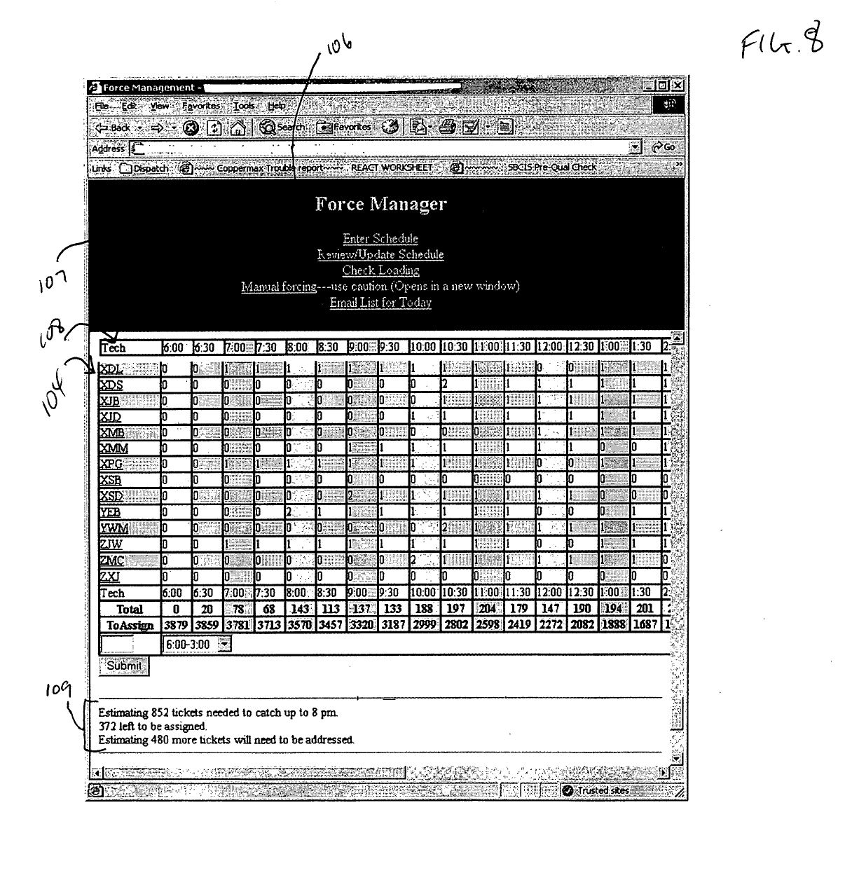

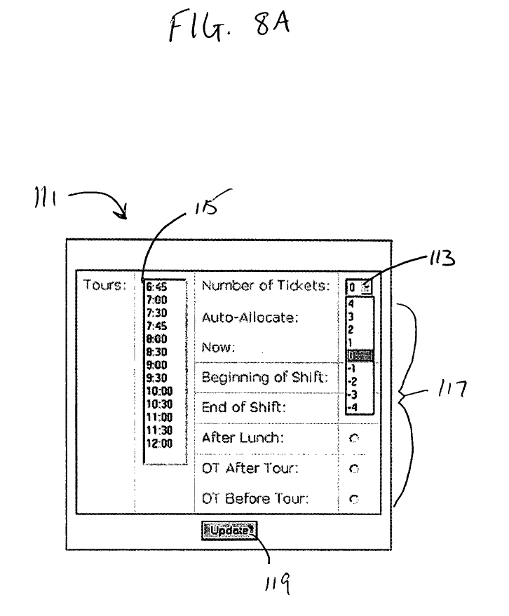

The overtime calculation may be linked up with the workload allocation server interface (referred to as the “Force Manager” in FIGS. 8-9) to provide an automated suggestion to managers of the number of hours of overtime needed per remaining workforce member for the day. The automated suggestion is made to the manager of how many additional hours will be needed to cover the workload based on number of items that need to be addressed and the number of people available for extra overtime hours. Once the suggestion is made the manager can adjust the suggested overtime (to increase or decrease individual workforce members overtime) and once the manager enters approval of the overtime distribution at the computer interface the approval flows/links to the workload allocation server which than updates its matrix to account for the extra hours. For example, if for the 7 a.m. to 4 p.m. shift two hours of overtime have been added, the workload allocation application in the workload allocation server will adjust end loading time (e.g. shift time) for that tour from 4 p.m. to 6 p.m. and continue to distribute work items until 6 p.m.

One example of a prioritization algorithm for use by the work force scheduling server 12 in assigning specific shifts in a tour to workforce members may include a straightforward seniority review. In this example, the schedule bidding application 24 would transmit instructions for generating a graphic user interface at a client device 20 operated by a workforce member who would query the workforce member for a login and password or other authentication information. Upon accepting the proffered authentication information, the schedule bidding application 24 would provide options to the workforce member in the form of shift times and days. The workforce member may then enter one or more preferences, ranked according to most preferred shift and/or day, and transmit that information back to the schedule bidding information.

After the close of the bidding period, the schedule bidding application will loop through the lists of NCTs in seniority order and assign the senior most NCT and loop through the NCTs preference submission, in order of preference, until an available match is found. The available tour matching the highest preference of the NCT will be assigned to that NCT and the schedule bidding application would decrement the number of that tour/shift available. If the information received on NCT preferences at the schedule bidding application did not match anything available in the tour list, that particular NCT is placed in a secondary list, again based on seniority. Once the schedule bidding application 24 has looped through all of the received preferences, the secondary list will be addressed.

The secondary list may be addressed by the schedule bidding application in an automatic fashion where the NCT on the secondary list is simply assigned an available tour position. The available tour positions may be ranked in terms of desirability on the system so that the highest desirability tour is automatically assigned to the highest seniority ranking NCT on the secondary list until all tours or NCTs are exhausted. Alternatively, NCTs on the secondary list that have not been assigned based on their express preference may be manually assigned by their manager to fill out the remaining work tours on the workforce schedule. This logic may be easily modified based on relevant business rules for contracts governing the employer implementing the method or system described herein.

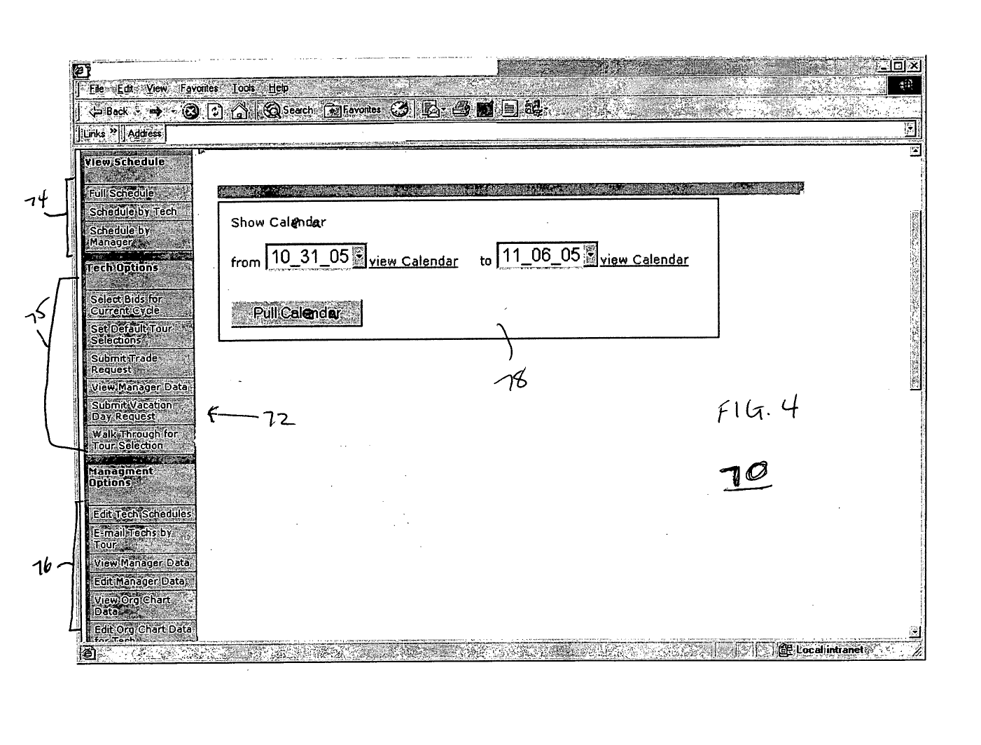

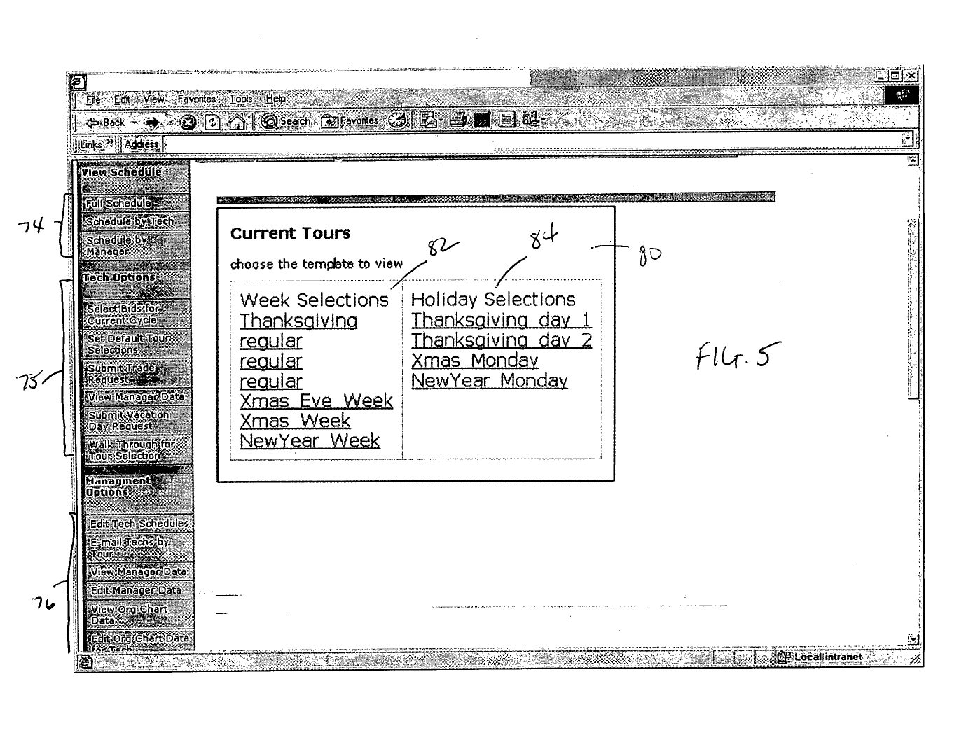

FIGS. 4-5 illustrate examples of a graphic user interface available for access by supervisors and managers, along with workforce members, for bidding on vacation schedules, work tours, and for allowing general schedule management. As described with reference to FIG. 2 above, the supervisors and workforce members each have access to different features and functions depending on their authorization level. For example, the rights to edit schedules for workforce members, such as NCTs, and overall schedule management may be limited to managers or certain managers based on login and authentication information. The scheduling screen 70 in FIG. 4 includes a taskbar selection menu 72 providing links to preconfigured views of schedules and schedule editing tools. A schedule viewing section 74 may include links showing a full tour schedule, schedules by technician, and schedules of technicians categorized by technician groups under specific managers. A technician options section 75 includes links to screens for selecting bids for current cycles, setting default tour selections, submitting requests to trade shifts, request vacation days and other technician data views and tools. A management options section 76 of the taskbar selection menu 72 may provide specific links to tools needed to edit schedule and vacation calendars, or contact workforce members regarding tour information.

The calendar selection box 78 permits users to identify which portion of a calendar or tour they wish to review and/or edit. This calendar box 78 may include pull down menus with dates, and/or graphics of calendars by month so that selection via only a mouse or other pointing device is available. FIG. 5 illustrates the web scheduling screen of the graphic user interface where a current tour selection box 80 has been pulled up by selecting the “Select Bids for Current Cycle” link in the technician options section 75 of the taskbar 72. The current tour box 80 provides prepopulated templates of useful groupings of dates within a tour. For example, a week selection box 82 may provide links to specific weeks within a tour and a holiday selections box 84 may be presented with links to specific holidays within the tour to provide easy and convenient links to portions of the tour that users, whether workforce members or managers, will need access to. The graphic user interface may be provided via standard Internet browser web access or other type of graphic user interface mechanism. The scheduling interface may communicate with the workforce scheduling server 12 and workload management server 14 via any of a number of known types of communication links. Also, the graphic user interface for providing access to the scheduling information may communicate with an ACD Symposium server to permit managers a real-time view of compliance with work breaks, lunches, phone activity and ACD agent performance.

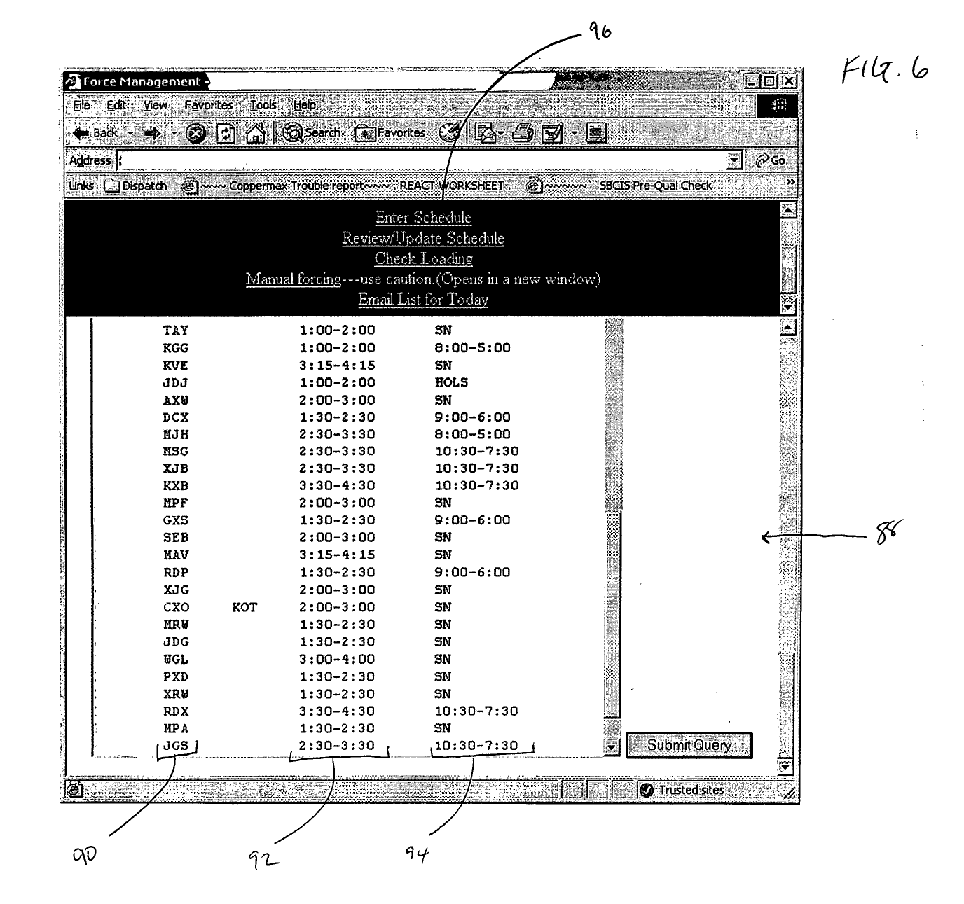

Referring to FIGS. 6-9, various screen shots of one graphic user interface operable on a client device 20 for allowing managers and supervisors to view and alter the workload distribution generated by the workload management server 14 is illustrated. The screen 88 shown in FIG. 6 is a schedule entry screen showing the list of NCTs by their initials. Other identifiers, such as employee ID codes specific to the company, may be used independently of, or in conjunction with, the initial identifiers 90. Additional information on the particular NCT may be shown, for example scheduled lunch break information 92 and shift data 94 indicating the hours within which that particular NCT is scheduled to work. The shift data 94 may alternatively include alphanumeric indicators for vacations or other status information for those NCTs who are not working that day. The schedule entry screen 88 may be accessed through a schedule entry link 96 automatically retrieving the workforce schedule generated by the workforce scheduling server 12 or permitting manual entry of the workforce schedule through cutting and pasting from another data file or manually entering the information.

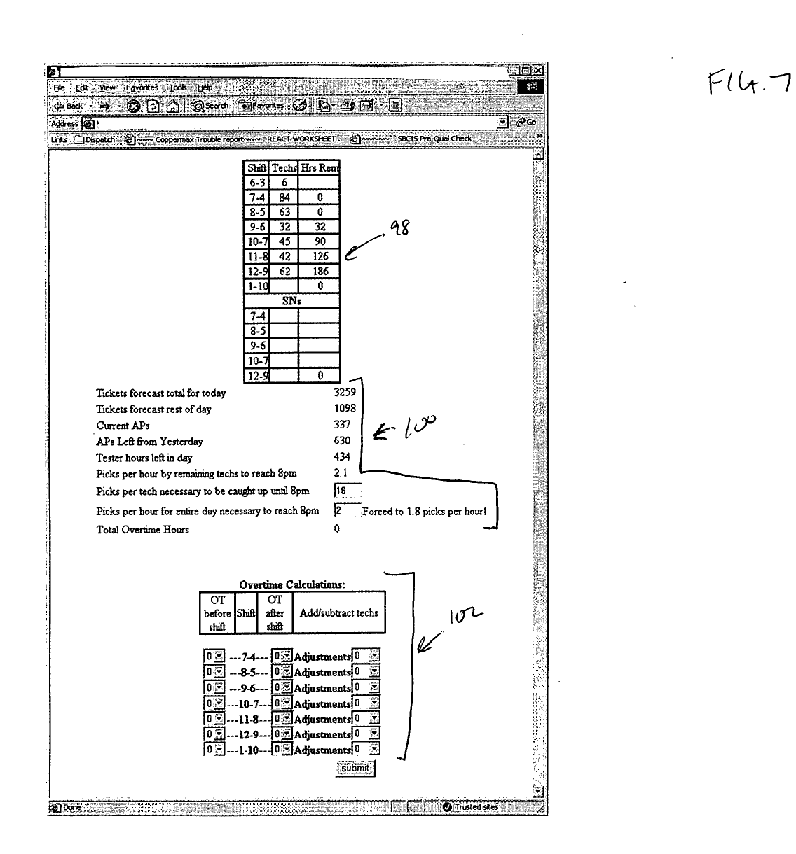

FIG. 7 illustrates another screen that the force manager interface to the workload management server 14 provides. Using the schedule that was retrieve and/or entered, the workload management server provides data to the interface that reports the number of technicians and the number of hours remaining in their work day in a shift summary display 98. Adjacent the shift summary display 98 is a forecast display 100 showing the number of trouble tickets forecasted by the workload management server based on current trouble tickets in the customer database and on the historical workload calculated via forecast formulas such as discussed above. Also available through the interface is a overtime calculation tool 102 allowing manual and/or automated adjustments of NCT schedules by shift. In one example, the overtime calculation tool may work directly from the overtime calculation generated through a formula such as discussed above where the workload management server generates a proposed adjustment to workforce members who still have portions of shifts left to complete for the day. Alternatively, the manager may manually select the number of overtime hours or technicians necessary.

Referring to FIG. 8, a workload display 104 can be generated by selecting the Review/Update Schedule link 106 on the graphic user interface. The display 104 may include alternating shading or coloring to contrast adjacent rows and/or columns for ease of viewing. The display 104 includes NCT ID information 108 and a grid showing the number of trouble tickets estimated for that NCT in half hour increments throughout the day. At the bottom of this screen a status listing 109 of tickets needed to be assigned and tickets estimated via the forecasting algorithm will be listed for review by the manager. From the display 104 shown in FIG. 8, a manager may select an individual technician to view in detail by selecting the link associated with that NCTs three initial identifier.

By selecting the “Manual Forcing” link 107 illustrated in FIG. 8, a manual forcing window 111 is displayed for the manager as shown in FIG. 8A. The manual forcing window 111 provides the manager with options for adding additional trouble ticket assignments to workforce member workloads during a current or upcoming shift that day, or for adding tickets to overtime assigned to workforce members. The manual forcing window 111 communicates with the workload management server 14 and automatically adjusts all workforce member workloads to take on the extra assignments (or reduce assignments) when the manager makes a selection as to the tours to be affected and the number of work items to be added or removed. A work item selector 113 in the window 111 permits the manager to enter the number of work items added to or removed from each of the workforce members to be affected. The selector 113 may be a pull-down menu with a scale having options for choosing additional work items (positive numbers) or removing work items (negative numbers).

A shift selection area 115 allows the manager to select among shifts beginning at specific times to be affected, or the manager may simply ignore specific shifts and the manual forcing window 111 will automatically apply the selected workload change indicated by the selector to all shifts still active or starting later in the day. A timing selection window 117 allows the manager to let the workload management server know when or how the workload changes are to be made. For example, the manager can have the workload management server automatically allocate the number of items designated in the work item selector 113, allocate the items immediately, allocate the changes at the beginning or end of shifts, and allocate the changes after each workforce member's lunch break. Alternatively, the manager can decide to only allocate the changes to overtime before or after a shift. When the manager has finished making the selections, an update button 119 communicates the selections to the workload management server and automatically makes the desired changes to all workforce members under the manager's supervision.

If individual workforce member schedule changes are desired, the manager can select a specific workforce member from the screen of FIG. 8. Selecting an NCT in FIG. 8 brings up an individual NCT display 110 is shown in FIG. 9. From this display 110, the manager can easily edit the number of trouble tickets per half hour increment displayed or can remove the workload from the NCT entirely by checking a clear all box 112. If a change is made to a particular NCT schedule, the NCTs direct manager and supervisors may be automatically emailed to inform them of changes in that NCTs schedule. The email may be generated by the workload management server in response to entry of data at the graphic user interface. In one embodiment, automatic updates to the manager and other supervisors for the NCT may be limited to situations where an NCTs workload is reduced via the graphic user interface. In addition to any notification via email of changes to NCT schedules that are sent to managers, an email or other messaging mechanism may be used to send a message to the NCT's workstation information the NCT that a change has been made to their schedule, for example that a new ticket has been assigned to them.

An advantage of the system and method discussed above is that managers and workforce managers may easily and quickly access updated data on work tours and workloads. Additionally, the automated forecasting tools which cooperate with the graphic user interface available to managers permits rapid and efficient reallocation of workload as dynamic workload demands develop throughout a particular day. The seamless integration of customer database information handling individual tickets and links to information that are provided to the NCTs as they work throughout the day may now also be fully integrated with a management interface to inform all managers and relevant NCTs of changes in their schedules. Greater flexibility is provided to managers through the forecasting tool which will allow them to make better use of manpower and reduce the time necessary to change schedules to react to changes in workload or workforce availability. A total view of all workforce administration and management components into a single interface is described. This interface can store historical reports, forecast work volumes and workforce modeling, build schedules, manage trades in tours and vacation requests, as well as distribute the work items based on priorities, forecasts and so on.

Within the graphic user interface provided to managers, there may also be links to workflow problems relating to ticket inactivity, multiple handoffs of a work ticket between various parties, general duration (delay) in handling tickets and those tickets with lack of updated status. This data may be broken down and displayed for managers by the type of ticket involved, for example residential versus business customer tickets. Also, automated email or messaging updates may be sent to various levels of managers depending on the severity of the problem so that those who are not currently logged in via the graphic user interface can be kept apprise. These automatic emails, sometimes referred to as escalation reminders, may include links to the specific trouble ticket in the customer database or a link to a web browser-based graphic user interface that will then pull up the data relevant to the linked trouble ticket on the managers computer.

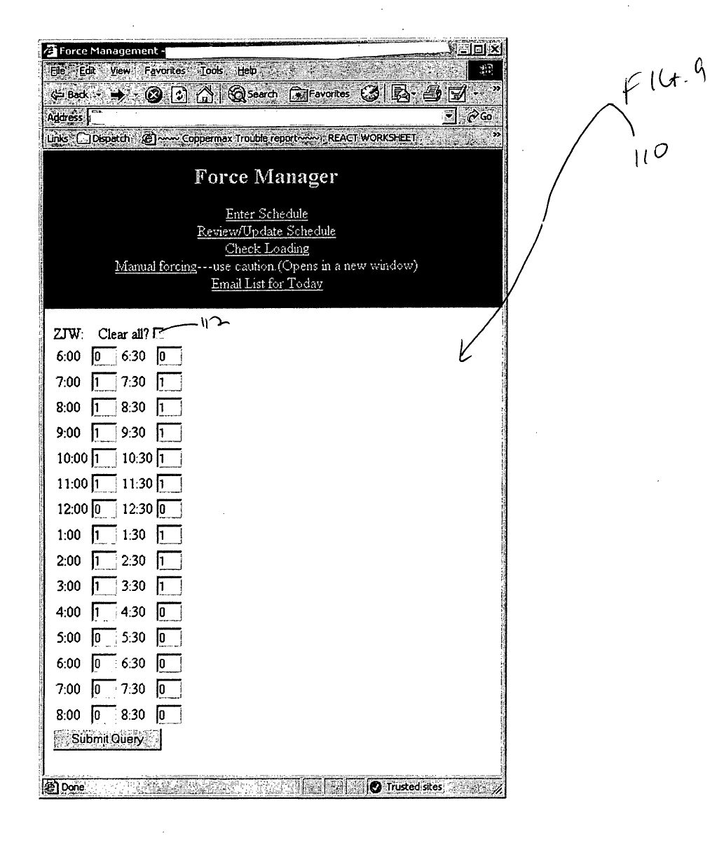

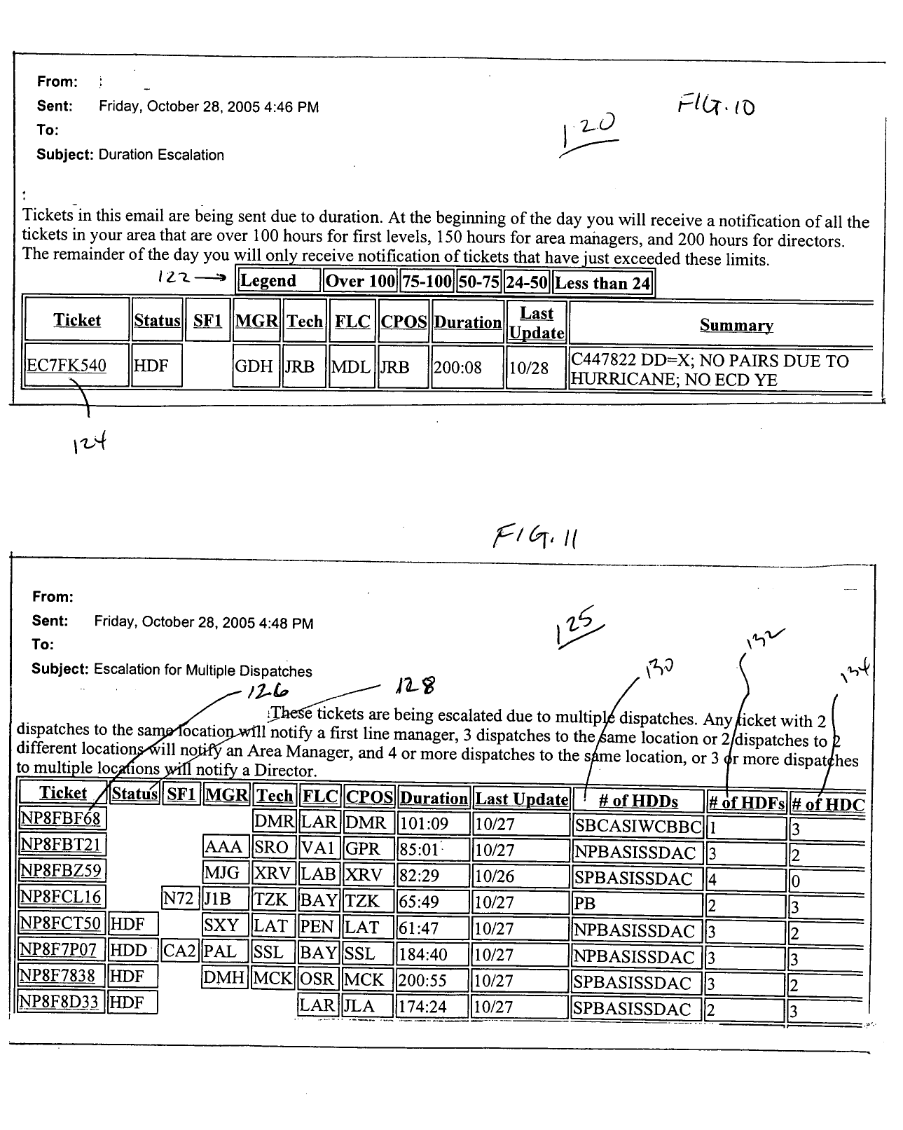

Examples of escalation reminder messages are shown in FIGS. 10-11. FIG. 10 shows an example of a duration escalation message 120 sent by the workload allocation server to a relevant manager. The duration escalation message 120 may include a trouble ticket display with a legend 122 showing color coded hour windows for the number of hours that a trouble ticket has been pending. A link 124 to the trouble ticket may be provided with status information as well as a list of parties responsible for handling the particular trouble ticket. Other information, such as the actual duration of the trouble tickets pendency and a short description of activity may also be included. FIG. 11 illustrates another type of escalation email, the information of which may also be viewed in various formats on the graphic user interface of the force manager tool.

The multiple dispatch escalation email 125 in FIG. 11 again provides the managers and other administration level recipients a link 126 to the customer database with detailed information on the escalated trouble ticket, including a status 128 indicating where that trouble ticket is currently residing. The multiple dispatches escalation data may also include statistics on the number of visits that this trouble ticket has made to different workgroups. For example, the identification code for the field personnel 130 who have handled the ticket, the number of times the trouble ticket has been handed off to the telephone company and the number of times the trouble ticket has been handed off to a network operating center 134. Here again, each escalation notification email may be preconfigured for automated transmission to various supervisors up the chain of command depending on the type of severity being tracked. In the case of multiple dispatch escalations, a total number of handoffs, or a total number of handoffs to a particular group in the chain may be designated as a threshold for sending information on a particular trouble ticket to a particular level of management.

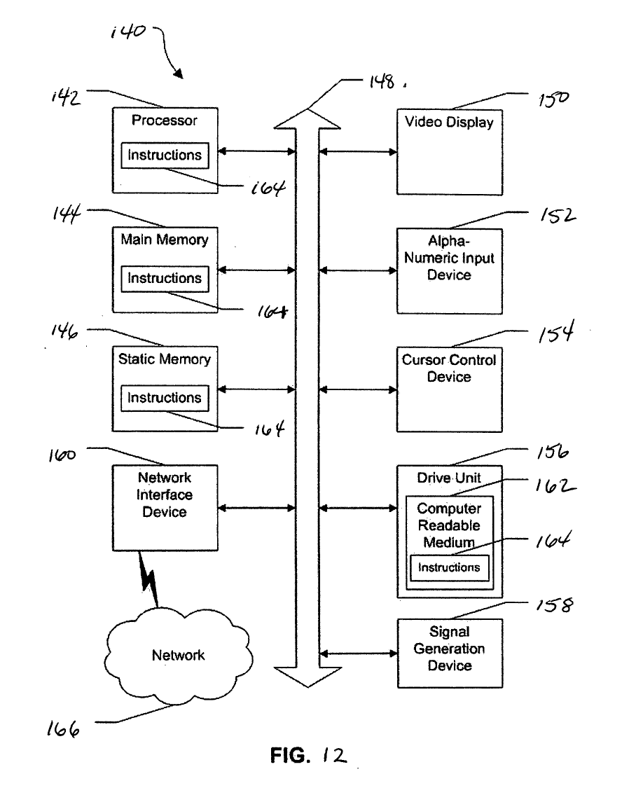

Any of a number of computer devices can be used for the workforce scheduling server 12, workload management server 14, client 20 or other components of the network 10. Referring to FIG. 12, an illustrative embodiment of a general computer system is shown and is designated 140. The computer system 140 can include a set of instructions that can be executed to cause the computer system 140 to perform any one or more of the methods or computer based functions disclosed herein. The computer system 140 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 140 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 140 can be implemented using electronic devices that provide voice, video or data communication. Further, while a single computer system 140 is illustrated, the term “system” shall also be taken to include any collection of systems or sub-systems that individually or jointly execute a set, or multiple sets, of instructions to perform one or more computer functions.

As illustrated in FIG. 12, the computer system 140 may include a processor 142, e.g., a central processing unit (CPU), a graphics processing unit (GPU), or both. Moreover, the computer system 140 can include a main memory 144 and a static memory 146 that can communicate with each other via a bus 148. As shown, the computer system 140 may further include a video display unit 150, such as a liquid crystal display (LCD), an organic light emitting diode (OLED), a flat panel display, a solid state display, or a cathode ray tube (CRT). Additionally, the computer system 140 may include an input device 152, such as a keyboard, and a cursor control device 154, such as a mouse. The computer system 140 can also include a disk drive unit 156, a signal generation device 158, such as a speaker or remote control, and a network interface device 160.

In a particular embodiment, as depicted in FIG. 12, the disk drive unit 156 may include a computer-readable medium 162 in which one or more sets of instructions 164, e.g. software, can be embedded. Further, the instructions 164 may embody one or more of the methods or logic as described herein. In a particular embodiment, the instructions 164 may reside completely, or at least partially, within the main memory 144, the static memory 146, and/or within the processor 142 during execution by the computer system 140. The main memory 144 and the processor 142 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 164 or receives and executes instructions 164 responsive to a propagated signal, so that a device connected to a network 166 can communicate voice, video or data over the network 166. Further, the instructions 164 may be transmitted or received over the network 166 via the network interface device 160.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A workforce management system for dynamically arranging work schedules and workloads, the system comprising:
a workload database comprising currently available assignments and historical workload levels; and
a workforce scheduling server comprising:
a business rule database comprising workforce hours requirements;
a workforce schedule application configured for automatically generating a workforce schedule based on historical workload data from the workload database and workforce hours requirements from the business rule database, wherein the workforce schedule comprises a plurality of work tours, each work tour having a predetermined daily schedule for a length of the work tour; and
a work tour bidding application configured to receive work tour preference requests from workforce members and generate a populated workforce schedule, wherein each of the workforce members is associated with a respective one of the plurality of work tours.

2. The system of claim 1, further comprising:
a workload allocation server in communication with the workforce scheduling server, the workload allocation server comprising an assignment distribution application configured to automatically forecast a daily workload based on the currently available assignments and historical workload levels, and configured to distribute assignments to each of the workforce members on the populated workforce schedule in response to the forecasted daily workload.

3. The system of claim 1, wherein the work tour bidding application comprises instructions for generating an interface to receive work tour preferences or vacation requests from workforce members.

4. The system of claim 3, wherein the work tour bidding application comprises a work tour priority routine responsive to received work tour preferences to assign work tours based on a priority rating associated with each workforce member.

5. The system of claim 4, wherein the priority rating comprises a seniority of a respective workforce member.

6. The system of claim 1, wherein the workforce schedule application comprises processor executable instructions for executing the following method:
a. retrieving historical workload data from the workload database for previous instances of a particular day of a week, the historical workload data comprising a number of assignments handled;
b. determining a predicted number of assignments by calculating an average of the number of assignments handled for the particular day of the week;
c. multiplying the average by an estimated time per assignment and applying the workforce hours requirements to determine a number of workforce members necessary to handle the predicted number of assignments; and
d. repeating steps a-c for each day of the week and generating the workforce schedule comprising a plurality of tours.

7. The system of claim 6, wherein instructions for determining the predicted number of assignments by calculating the average, comprise instructions for calculating a weighted average of the number of assignments handled in a previous N instances of the particular day of the week, wherein more recent instances of the particular day of the week are weighted more heavily than older instances.

8. The system of claim 6, wherein the instructions for determining the predicted number of assignments comprise instructions for determining an average number of work items received (A_{[d, h]}) for a given hour of a given day of the week according to the relation:
$$\begin{matrix}{A}_{[ d , h ]} = {T}_{[ d , h , 0 ]} * ( 0.25 ) + {T}_{[ d , h , 1 ]} * ( 0.25 ) + \\ {T}_{[ d , h , 2 ]} * ( 0.166 ) + {T}_{[ d , h , 3 ]} * ( 0.166 ) \\ = {T}_{[ d , h , 4 ]} * ( 0.0833 ) + {T}_{[ d , h , 5 ]} * ( 0.0833 )\end{matrix}$$
where h=Hour of day, d=Day of week, T[d, h, w]=Number of work items received in [h] hour of [d] day in [w] week, with w represented by previous weeks 0-5.

9. A method of dynamically arranging work schedules comprising:
retrieving historical workload data from a workload database and business rule data from a business rule database;
automatically generating a workforce schedule template comprising a plurality of work tours based on the retrieved historical workload data and business rule data, wherein each work tour comprises a predetermined daily schedule for a length of the work tour;
receiving work tour preference requests from workforce members;
automatically generating a populated workforce schedule by populating the workforce schedule template based on the received work tour preference requests, wherein each of a plurality of workforce members is associated with a respective one of the plurality of work tours.

10. The method of claim 9 further comprising transmitting to a client instructions for generating a graphic user interface configured to receive work tour preference requests.

11. The method of claim 9, wherein automatically generating a populated workforce schedule template comprises automatically processing all received work tour preference requests to assign work tours based on a priority rating associated with each workforce member.

12. The method of claim 9, wherein the priority rating comprises a seniority of a respective workforce member and processing all received workforce tour preference requests, comprises assigning work tours to workforce members in order of seniority.

13. The method of claim 9, further comprising:
automatically forecasting at a beginning of a day of a work tour a workload allocation based on currently available assignments and historical workload levels; and
distributing assignments among the workforce members on the populated workforce schedule based on the forecasted daily workload.

14. The method of claim 13, further comprising updating the workload allocation on a periodic basis during the day, wherein dynamic changes in a number or type of currently available assignments are accounted for.

15. The method of claim 13, further comprising automatically forecasting an amount of overtime hours necessary to complete a forecasted amount of workload if the forecasted amount of workload exceeds a current workforce capacity.

16. The method of claim 13, wherein automatically forecasting at the beginning of the day comprises:
retrieving the populated workforce schedule, currently available assignments and historical workload levels from the workload database; and
forecasting a present day workload based on the currently available assignments and historical workload levels.

17. The method of claim 15, further comprising automatically alerting a manager of a need to schedule overtime via a manager interface.

18. A computer readable medium comprising instructions for carrying out the following steps:
retrieving historical workload data from a workload database and business rule data from a business rule database;
automatically generating a workforce schedule template comprising a plurality of work tours based on the retrieved historical workload data and business rule data, wherein each work tour comprises a predetermined daily schedule for a length of the work tour;
receiving work tour preference requests from workforce members;
automatically generating a populated workforce schedule by populating the workforce schedule template based on the received work tour preference requests, wherein each of a plurality of workforce members is associated with a respective one of the plurality of work tours.

19. The computer readable medium of claim 18, further comprising instructions for transmitting to a client instructions for generating a graphic user interface configured to receive work tour preference requests.

20. The computer readable medium of claim 18, wherein instructions for automatically generating a populated workforce schedule template comprise instructions for automatically processing all received work tour preference requests to assign work tours based on a priority rating associated with each workforce member.

21. The computer readable medium of claim 18, further comprising instructions for executing the following steps:
automatically forecasting at a beginning of a day of a work tour a workload allocation based on currently available assignments and historical workload levels; and
distributing assignments among the workforce members on the populated workforce schedule based on the forecasted daily workload.
